(19) United States
(12) Patent Application Publication
(10) Pub. No.: US 2023/0196457 A1
(43) Pub. Date: Jun. 22, 2023

(54) SYSTEM FOR MANAGING INVESTMENT INFORMATION AND EXPEDITED TRADING

(71) Applicants: Hunter Slay, Eureka Springs, AR (US); William R. Moore, Avinger, TX (US)

(72) Inventors: Hunter Slay, Eureka Springs, AR (US); William R. Moore, Avinger, TX (US)

(21) Appl. No.: 17/557,905

(22) Filed: Dec. 21, 2021

(51) Int. Cl. G06Q 40/04; G09B 9/00

(52) U.S. Cl. CPC G06Q 40/04; G09B 9/00

(57) ABSTRACT

A system for managing investment information and knowledge is disclosed, comprising at least one database configured to store a plurality of user and stock market information. A portfolio database stores portfolio information for a plurality of users, accessible via a computing device. A teaching system is in operable communication with a teaching database and a teaching server to provide instructional information. An evaluation system is in operable communication with an evaluation database and an evaluation server to provide evaluations related to one or more trading techniques.

### CROSS-REFERENCE TO RELATED APPLICATION

This application claims the benefit of U.S. Provisional Application No. 63/043,662 filed Jun. 24, 2020 and which is incorporated herein by reference.

### TECHNICAL FIELD

The embodiments generally relate to computer implemented systems for financial market analysis and evaluation.

### BACKGROUND

The analysis and evaluation of stocks based on accepted guidelines and historical market statistics has become increasingly popular with the advancement of computing technologies. Advances in computing technologies, including database mining and management, search engines, and data modeling have provided increasingly sophisticated approaches to processing vast amounts of data. This has been especially useful in processing financial data, including stock market data. Recent tools provide early indicators of changes in the market based on various statistical methods. Each method provides the trader with a variety of information to inform their investment decisions.

While there is no shortage of information for knowledgeable traders, many of the tools are far too complex for novice traders to easily comprehend and implement when trading. This results in frustration and the potential for lost money due to ineffective or inefficient trading practices. Few tools are available for teaching stock trading.

### SUMMARY OF THE INVENTION

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

The embodiments provided herein relate to a system for managing investment information and knowledge, comprising at least one database configured to store a plurality of user information and stock market information. A portfolio database may store portfolio information for a plurality of users, accessible via a computing device.

The system allows for implementation in a real-world investment environment as well as a simulated investment environment. Various currencies may be utilized including fiat currencies, real-world currencies, blockchain implemented currencies (e.g., BitCoin), and the like.

In one aspect, the system may include a trading module configured to receive user input of at least one of review, buy, sell, or otherwise interact with historical trading data in order to simulate trading

In one aspect, the system may include an instruction module that may provide instructional content related to one or more investment strategies to a user.

In one aspect, a gamification system provides at least one game to the user.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a block diagram of the network infrastructure, according to some embodiments;

FIG. 2 illustrates a block diagram of the server engine and modules, according to some embodiments;

FIG. 3 illustrates a block diagram of the server engine, according to some embodiments;

and

FIG. 4 illustrates a block diagram of the server engine and modules, according to some embodiments.

### DETAILED DESCRIPTION

The specific details of the single embodiment or variety of embodiments described herein are to the described system and methods of use. Any specific details of the embodiments are used for demonstration purposes only, and no unnecessary limitations or inferences are to be understood therefrom.

Before describing in detail exemplary embodiments, it is noted that the embodiments reside primarily in combinations of components and procedures related to the system. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In this disclosure, the various embodiments may be a system, method, apparatus, or computer program product at any possible technical detail level of integration. A computer program product can include, among other things, a computer-readable storage medium having computer-readable program instructions thereon for causing a processor to carry out aspects of the present disclosure.

As used herein, the term “user” may relate to any person interacting with the various features of the system provided herein and may include investors (whether experienced or learning) as well as users who may evaluate or teach other users. Users may also include administrative users of the system.

As used herein, the terms “simulate,” “simulation,” or variations of those terms may include the simulation of stock market trading or user activity based on the use of existing historical trading data. Gamification and trading content may allow users to perform actions, such as, but not limited to, buying, selling, or the like of stocks, ETF's, or the like based upon historical market data in a non-real world environment.

As used herein, “GUI” may refer to any graphical user interface that includes at least one interactive component between a user and the application. A GUI may include a plurality of Tillable fields, clickable buttons, database displays, or the like. A GUI maybe adaptable for use on several devices such as computers, phones, smart devices, tablets, laptops, televisions, or the like.

In this disclosure, terms “store,” “storage,” “data store,” “data storage,” “database,” and substantially any other information storage component relevant to operation and functionality of a component are utilized to refer to “memory components,” which are entities embodied in a “memory,” or components comprising a memory. Those skilled in the art would appreciate that the memory or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random-access memory (RAM) (e.g., ferroelectric RAM (FeRAM). Volatile memory can include, for example, RAM, which can act as external cache memory. The memory or memory components of the systems or computer-implemented methods can include the foregoing or other suitable types of memory.

Generally, a computing device will also include, or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

As used herein, the term “investment information” may include any investing portfolio information, financial management information, teaching information, evaluation information, and market indicators. Such market indicators may include those known in the arts such as Bollinger bands, PIP's, Pivot points, relative strength index (RSI), stochastic models, ticks, and the like. Bollinger Band are a technical analysis technique in which lines are plotted two standard deviations above and below a moving average, and at the moving average itself. Because standard deviation measures volatility, these bands will be wider during increased volatility and narrower during decreased volatility. Some technical analysts consider a market which approaches the upper band to be overbought, and a market which approaches the lower band to be oversold. A PIP is the smallest price change that a given exchange rate can make. Since most major currency pairs are priced to four decimal places, the smallest change is that of the last decimal point—for most pairs this is the equivalent of 1/100th of one percent, or one basis point. A pivot point is a technical indicator derived by calculating the numerical average of a particular stock's high, low, and closing prices. The pivot point is used as a predictive indicator. If the following day's market price falls below the pivot point, it may be used as a new resistance level. Conversely, if the market price rises above the pivot point, it may act as the new support level. RSI is a technical analysis indicator which measures the magnitude of gains over a given time period against the magnitude of losses over that period. The equation is RSI=100−100/(1+RS) where RS=(total gains/n)/(total losses/n) and n=number of RSI periods. A stochastic model is a model based on the belief that as prices increase (or decrease), closing prices tend to accumulate ever more closely to the highs (or lows) for a given period. A tick is one completed transaction, for example five ticks refers to five completed transactions.

In some embodiments, the system provides a means for assisting instruction and evaluation of stock trading using a computing device. In general, the system may provide instructional content related to one or more investment strategies to a user via an instructional module. The instructional material may be generally related to investing and finances and may include materials such as lectures, presentations, reading material, learning exercises, and the like. The system may also be constructed and arranged to provide gaming content to a user via a gamification module. Gamification content may include games or exercises disguised as games, including incentivization features, constructed and arranged to facilitate a user learning investing and financing techniques and strategies similar to that which is disclosed in the instructional material. Gamification content may be complementary to the instructional material in that it may reinforce learning of the material through exercises and games.

The system may include a trading module configured to receive user input of at least one of review, buy, sell, or otherwise interact with historical trading data in order to simulate trading. The system may include at least one database or portfolio database in operable communication with a computing device, such as a processor. The at least one database may store user or stock market historical data. The at least one portfolio database may be configured to store portfolio information for at least one user, the portfolio information database being accessible via the at least one computing device. The trading module may be constructed and arranged to condense historical data from at least one of the database or portfolio database such that a user may review, buy, sell, or interact with condensed historical data to simulate stock market trading. The trading module may be configured to condense historical data by at least one of correlating, aggregating, summarizing, curtailing, abridging, or concentrating historical trading data.

According to some embodiments, historical data may be condensed and delivered to a user, says such as a display on a computing device, at a rate of approximately 200 times historical speed such that a user may review, buy, sell, or interact with condensed historical data via their computing device and a simulated trading protocol operating thereon. In some embodiments, the system allows for accelerated learning of trading concepts to gain a large amount of experience in a condensed time period. Often, it may take years to become comfortable with trading techniques and their applications. The system provides the user with a condensed time frame for analyzing large amounts of data such that, the user may interact with an entire day's worth of data in a timespan of just a few minutes. The system may be constructed and arranged to record minute to minute historical data and allow a player to simulate trading, in a round of a game, and receive 24 hours of historical trading data at up to 200 times speed such that a user may receive 24 hours of historical trading data within a two-minute window and be allowed to review, buy, sell, and otherwise interact with condensed data in a short time frame. As a non-limiting example, the system may use historical trading data to provide the framework for gamification content such that a user may interact with real world historical market data in a non-real-world environment such as a game involving day trading. The system may be constructed and arranged to save user activity data during this particular period of time, such as a 24-hour period of time, and may compare user activity to determine user success according to percentile relative to other user activity interacting with the same or similar set of historical data.

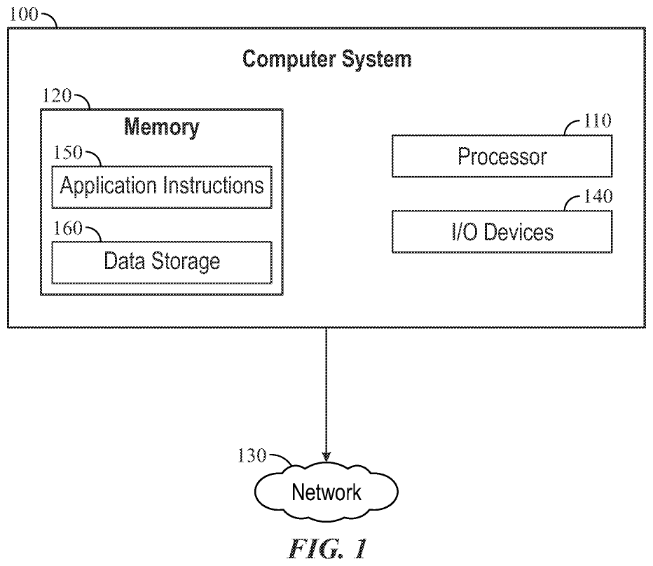

FIG. 1 illustrates a computer system 100, which may be utilized to execute the processes described herein. The computer system 100 is comprised of a standalone computer or mobile computing device, a mainframe computer system, a workstation, a network computer, a desktop computer, a laptop, or the like. The computer system 100 includes one or more processors 110 coupled to a memory 120 via an input/output (I/O) interface. Computer system 100 may further include a network interface to communicate with the network 130. One or more input/output (I/O) devices 140, such as video device(s) (e.g., a camera), audio device(s), and display(s) are in operable communication with the computer system 100. In some embodiments, similar I/O devices 140 may be separate from computer system 100 and may interact with one or more nodes of the computer system 100 through a wired or wireless connection, such as over a network interface.

Processors 110 suitable for the execution of a computer program include both general and special purpose microprocessors and any one or more processors of any digital computing device. The processor 110 will receive instructions and data from a read-only memory or a random-access memory or both. The essential elements of a computing device are a processor for performing actions in accordance with instructions and one or more memory devices for storing instructions and data. Generally, a computing device will also include, or be operatively coupled to receive data from or transfer data to, or both, one or more mass storage devices for storing data, e.g., magnetic, magneto-optical disks, or optical disks; however, a computing device need not have such devices. Moreover, a computing device can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

A network interface may be configured to allow data to be exchanged between the computer system 100 and other devices attached to a network 130, such as other computer systems, or between nodes of the computer system 100. In various embodiments, the network interface may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network or protocol.

The memory 120 may include application instructions 150, configured to implement certain embodiments described herein, and a database 160, comprising various data accessible by the application instructions 150. In one embodiment, the application instructions 150 may include software elements corresponding to one or more of the various embodiments described herein. For example, application instructions 150 may be implemented in various embodiments using any desired programming language, scripting language, or combination of programming languages or scripting languages (e.g., C, C++, C#, JAVA®, JAVASCRIPT®, PERL®, etc.).

In some embodiments, the memory 120 may be utilized to store investor portfolio information, store user credentials, store user preferences, store historical market data, and to store the various systems for managing investment information utilized by the application.

The steps and actions of the computer system 100 described in connection with the embodiments disclosed herein may be embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

Also, any connection may be associated with a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc,” as used herein, include compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

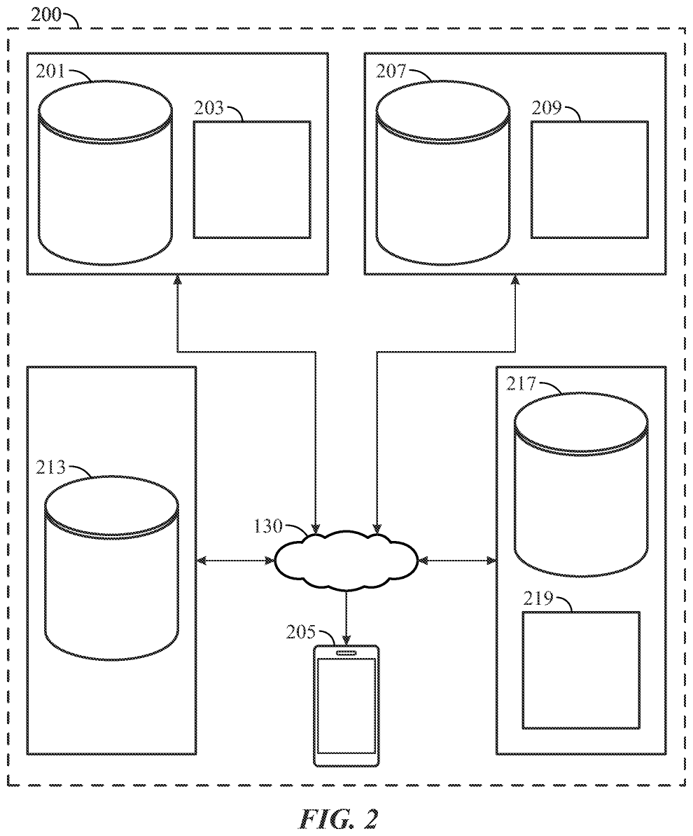

FIG. 2 illustrates a block diagram of the system for managing investment information 200 including a portfolio database 201 and portfolio server 203 operable to store and transmit information related to the user's portfolio, via the network 130, to the computing device 205 operating the application system. A gaming database 207 is in operable communication with a gaming server 209, which provides a gaming program via a gaming application to allow the user to interact with the various features thereof. A trading module 213 is in operable communication with the portfolio database 201 and portfolio server 203 to store and transmit information related to a simulated trading protocol. A teaching database 217 in operable communication with a teaching server 219, which sends and receives information related to teaching elements provided by the system.

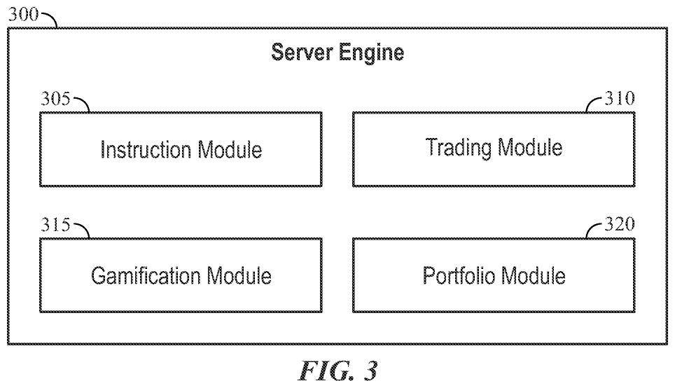

FIG. 3 illustrates a block diagram of the server engine 300 and modules thereof, including an instruction module 305 configured to generate instructional content and processes related to teaching at least one user various principles, techniques, and protocols related to stock market trading. An trading module 310 may implement a trading protocol to condense and deliver historical data to a user, such as via a display on a computing device, at a rate of approximately 200 times historical speed such that a user may review, buy, sell, or interact with condensed historical data via their computing device. A gamification module 315 may be provided to allow the user to interact with various games provided by the system, including simulated trading in cooperation with the trading module 310. Each game may relate to a one or more investment strategies, market information, and the like to provide a simulated trading experience, without the need for the user to risk money while learning. A portfolio module 320 may allow the user to interact with various elements of a real or simulated portfolio based on historical trading data.

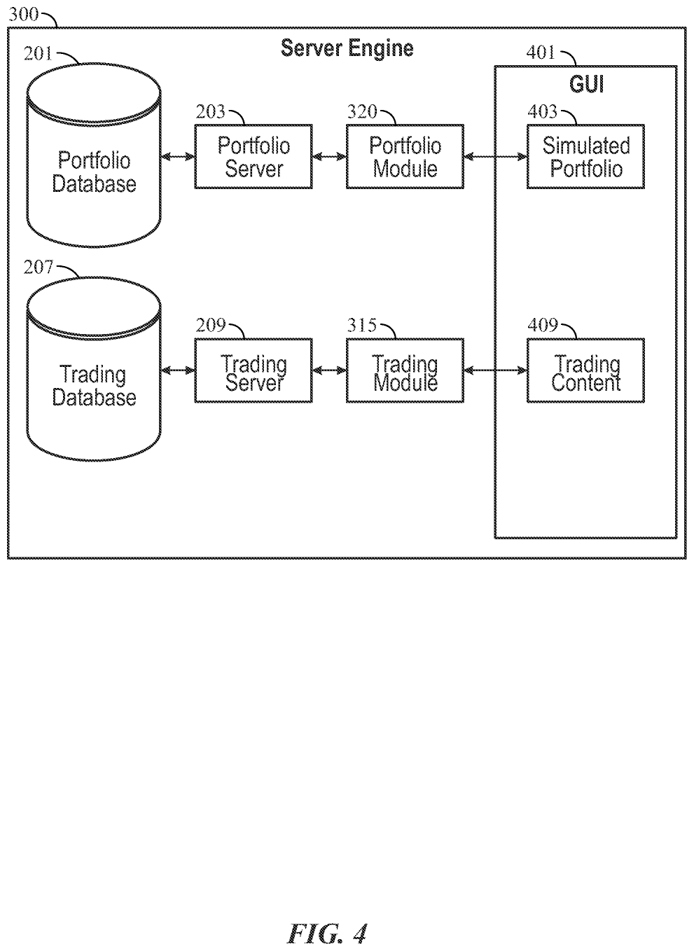

FIG. 4 illustrates a diagram of the server engine 300 and modules thereof, including a portfolio module 320 in operable communication with a portfolio server 203 in operable communication with a portfolio database 201. The portfolio module 320 may allow the user to interact with various elements of a real or simulated portfolio. As a non-limiting example, the portfolio module 302 may provide a means for a user to interact with a real or simulated portfolio 403 via a GUI 401 on the user's device. The simulated portfolio 403 may include information relating to portfolio value, portfolio positions, orders, transfers, trades, and various other market information whether real or simulated. The portfolio module may provide information to the user via the simulated portfolio 403 in various forms such as tables, graphs, and the like.

The server engine 300 may include a trading module 315 in operable communication with a trading server 209 in operable communication was a trading database 207. The trading module 315 may be provided to allow the user to interact with various games or simulated trading scenarios provided by the system. The trading module 315 may be constructed and arranged to retrieve minute to minute historical data from the trading database 207 or the portfolio database 201 and allow a player to simulate trading and receive 24 hours of historical trading data at up to 200 times normal-speed such that a user may receive 24 hours of historical trading data within a two minute window and be allowed to review, buy, sell, and otherwise interact with condensed data in a short time frame. Each trading scenario may relate to a one or more investment strategies, market information, and the like to provide a simulated trading experience, without the need for the user to risk money while learning.

The following description of variants is only illustrative of components, elements, acts, products, and methods considered to be within the scope of the invention and are not in any way intended to limit such scope by what is specifically disclosed or not expressly set forth. The components, elements, acts, products, and methods as described herein may be combined and rearranged other than as expressly described herein and are still considered to be within the scope of the invention.

According to variation 1, a system for evaluating investment information and simulating expedited trading, the system including at least one computing device in operable connection with a network; a memory that stores computer-executable components; a processor that executes the computer-executable components stored in the memory. The computer-executable components include an application in communication with the computing device, the application including a simulation system to provide at least one simulation to the user; at least one database configured to store a plurality of user and stock market information; a portfolio database to store portfolio information for a plurality of users, accessible via the at least one computing device; a trading module being constructed and arranged to retrieve historical data from at least one of the database or portfolio database and allow a user to simulate trading and receive historical trading data at up to about 200 times normal-speed such that a user may be allowed to review, buy, sell, or interact with condensed data.

Variation 2 may include a system for evaluating investment information and simulating expedited trading as in variation 1, wherein historical trading data includes approximately twenty-four hours of historical trading data.

Variation 3 may include a system for evaluating investment information and simulating expedited trading as in any of variations 1 through 2, wherein historical trading data includes more than approximately twenty-four hours of historical trading data.

Variation 4 may include a system for evaluating investment information and simulating expedited trading as in any of variations 1 through 3, wherein historical trading data includes less than approximately twenty-four hours of historical trading data.

Variation 5 may include a system for evaluating investment information and simulating expedited trading as in any of variations 1 through 4, wherein historical data includes simulated historical data.

Variation 6 may include a system for evaluating investment information and simulating expedited trading as in any of variations 1 through 5, wherein receiving historical trading data at up to about 200 times normal speed includes receiving 24 hours of historical trading data within a two-minute window such that a user may review, buy, sell, or interact with condensed data in a short time frame.

Variation 7 may include a system for evaluating investment information and simulating expedited trading as in any of variations 1 through 6, further including an instruction module to provide instruction related to one or more investment strategies.

Variation 8 may include a system for evaluating investment information and simulating expedited trading as in any of variations 1 through 7, further including a gamification system to provide at least one game to the user.

Variation 9 may include a system for evaluating investment information and simulating expedited trading as in any of variations 1 through 8, wherein the gamification system is constructed and arranged to provide gamification content such that a user may interact with real world historical market data in a non-real-world environment.

Variation 10 may include a system for evaluating investment information and simulating expedited trading as in any of variations 1 through 9, wherein allowing a user to simulate trading and receive historical trading data at up to about 200 times normal-speed such that a user may be allowed to review, buy, sell, or interact with condensed data occurs within a predetermined period.

Variation 11 may include a system for evaluating investment information and simulating expedited trading as in any of variations 1 through 10, wherein the predetermined period is about two minutes or less.

According to variation 12, a method for managing investment information may include at least one computing device; a memory that stores computer-executable components; a processor that executes the computer-executable components stored in the memory. The computer-executable components including retrieving historical data from at least one of a database or a portfolio database in operable communication with the memory and the processor, the at least one database being configured to store a plurality of user and stock market information and the portfolio database being configured to store portfolio information for a plurality of users, accessible via the at least one computing device; condensing historical data from at least one of a database or a portfolio database; communicating condensed historical data to a user; and receiving user input of at least one of review, buy, sell, or interact with historical data to simulate trading.

Variation 13 may include a method for managing investment information as in variation 12, wherein condensing historical data from at least one of a database or a portfolio database comprises at least one of correlating, aggregating, summarizing, curtailing, abridging, or concentrating historical data.

Variation 14 may include a method for managing investment information as in any of variations 12 through 13, wherein the computer-executable components allow a user to simulate trading and receive historical trading data at up to about 200 times normal-speed such that a user provides user input to review, buy, sell, or interact with condensed data via a second computing device.

Variation 15 may include a method for managing investment information as in any of variations 12 through 14, further recording comprising historical trading data to the database or a portfolio database prior to retrieving historical data from at least one of a database or a portfolio database.

Variation 16 may include a method for managing investment information as in any of variations 12 through 15, wherein communicating condensed historical data to a user comprises displaying condensed historical data on a display of a second computing device.

Variation 17 may include a method for managing investment information as in any of variations 12 through 16, wherein receiving user input of at least one of review, buy, sell, or interact with historical data to simulate trading occurs within a predetermined period after communicating condensed historical data to a user.

Variation 18 may include a method for managing investment information as in any of variations 12 through 17, wherein the predetermined period is about two minutes or less.

Variation 19 may include a method for managing investment information as in any of variations 12 through 18, further comprising modifying condensed historical data based on user input to reflect simulated trading results.

According to variation 20, a method for managing investment information may include at least one computing device in operable communication with a user device over a network; a memory that stores computer-executable components; a processor that executes the computer-executable components stored in the memory. The computer-executable components may include recording comprising historical trading data to a database or a portfolio database; retrieving historical data from at least one of a database or a portfolio database in operable communication with the memory and the processor, the at least one database being configured to store a plurality of user and stock market information and the portfolio database being configured to store portfolio information for a plurality of users, accessible via the at least one computing device; condensing historical data from at least one of a database or a portfolio database; communicating condensed historical data to the user device over the network; and receiving user input of at least one of review, buy, sell, or interact with historical data to simulate trading within a predetermined period; and modifying condensed historical data based on user input to reflect simulated trading results.

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible in light of the above teachings without departing from the following claims.

1. A system for evaluating investment information and simulating expedited trading, the system comprising:
at least one computing device in operable connection with a network;
a memory that stores computer-executable components;
a processor that executes the computer-executable components stored in the memory, wherein the computer-executable components comprise:
an application in communication with the computing device, the application comprising a simulation system to provide at least one simulation to a user;
at least one database configured to store a plurality of users and stock market information;
a portfolio database to store portfolio information for a plurality of users, accessible via the at least one computing device;
a trading module being constructed and arranged to retrieve historical data from at least one of the database or portfolio database and allow the user to simulate trading and receive historical trading data at up to 200 times normal-speed such that the user may be allowed to review, buy, sell, or interact with condensed data.

2. The system for evaluating investment information and simulating expedited trading as in claim 1, wherein historical trading data comprises twenty-four hours of historical trading data.

3. The system for evaluating investment information and simulating expedited trading as in claim 1, wherein historical trading data comprises more than twenty-four hours of historical trading data.

4. The system for evaluating investment information and simulating expedited trading as in claim 1, wherein historical trading data comprises less than twenty-four hours of historical trading data.

5. The system for evaluating investment information and simulating expedited trading as in claim 1, wherein historical data comprises simulated historical data.

6. The system for evaluating investment information and simulating expedited trading as in claim 1, wherein receiving historical trading data at up to 200 times normal-speed comprises receiving 24 hours of historical trading data within a two-minute window such that the user may review, buy, sell, or interact with condensed data in a short time frame.

7. The system for evaluating investment information and simulating expedited trading as in claim 1, further comprising an instruction module to provide instruction related to one or more investment strategies.

8. The system for evaluating investment information and simulating expedited trading as in claim 1, further comprising a gamification system to provide at least one game to the user.

9. The system for evaluating investment information and simulating expedited trading as in claim 8, wherein the gamification system is constructed and arranged to provide gamification content such that the user may interact with real world historical market data in a non-real-world environment.

10. The system for evaluating investment information and simulating expedited trading as in claim 9, wherein allowing the user to simulate trading and receive historical trading data at up to 200 times normal-speed such that the user may be allowed to review, buy, sell, or interact with condensed data occurs within a predetermined period.

11. The system for evaluating investment information and simulating expedited trading as in claim 10, wherein the predetermined period is two minutes or less.

12. A method for managing investment information, the method comprising:
at least one computing device;
a memory that stores computer-executable components;
a processor that executes the computer-executable components stored in the memory, wherein the computer-executable components comprise:
retrieving historical data from at least one of a database or a portfolio database in operable communication with the memory and the processor, the at least one database being configured to store a plurality of user and stock market information and the portfolio database being configured to store portfolio information for a plurality of users, accessible via the at least one computing device;
condensing historical data from at least one of the database or the portfolio database;
communicating condensed historical data to the user; and
receiving a user input of at least one of review, buy, sell, or interact with historical data to simulate trading.

13. The method as in claim 12, wherein condensing historical data from at least one of the database or the portfolio database comprises at least one of correlating, aggregating, summarizing, curtailing, abridging, or concentrating historical data.

14. The method as in claim 12, wherein the computer-executable components allow a user to simulate trading and receive historical trading data at up to 200 times normal-speed such that the user provides the user input to review, buy, sell, or interact with condensed data via a second computing device.

15. The method as in claim 12, further recording comprising historical trading data to the database or the portfolio database prior to retrieving historical data from at least one of the database or the portfolio database.

16. The method as in claim 12, wherein communicating condensed historical data to the user comprises displaying condensed historical data on a display of a second computing device.

17. The method as in claim 12, wherein receiving the user input of at least one of review, buy, sell, or interact with historical data to simulate trading occurs within a predetermined period after communicating condensed historical data to the user.

18. The method as in claim 12, wherein the predetermined period is two minutes or less.

19. The method as in claim 12, further comprising modifying condensed historical data based on the user input to reflect simulated trading results.

20. A method for managing investment information, the method comprising:
at least one computing device in operable communication with a user device over a network;
a memory that stores computer-executable components;
a processor that executes the computer-executable components stored in the memory, wherein the computer-executable components comprise:
recording comprising historical trading data to a database or a portfolio database;
retrieving historical data from at least one of the database or the portfolio database in operable communication with the memory and the processor, the at least one database being configured to store a plurality of the user and stock market information and the portfolio database being configured to store portfolio information for a plurality of users, accessible via the at least one computing device;
condensing historical data from at least one of the database or the portfolio database;
communicating condensed historical data to the user device over the network; and
receiving a user input of at least one of review, buy, sell, or interact with historical data to simulate trading within a predetermined period; and
modifying condensed historical data based on the user input to reflect simulated trading results.
